(19) United States
(12) Patent Application Publication
(10) Pub. No.: US 2008/0137846 A1
(43) Pub. Date: Jun. 12, 2008

(54) Ram- Based Scrambling Code Generator for Cdma

(76) Inventors: Alton Shelborne Keel, Melbourne, FL (US); Louis Robert Litwin, Plainsboro, NJ (US); Zoran Kostic, Holmdel, NJ (US)

Correspondence Address: Joseph J. Laks;Thomson Licensing LLC, 2 Independence Way, Patent Operations, PO Box 5312, PRINCETON, NJ, 08543, US

(21) Appl. No.: 11/794,973

(22) PCT Filed: Jan. 14, 2005
(86) PCT No.: PCT/US05/01177

§ 371 Date: Jul. 9, 2007

(51) Int. Cl. H04K 1/10

(52) U.S. Cl. 380/33

(57) ABSTRACT

A receiver comprises a memory for storing a scrambling code value and a plurality of fingers, wherein each of the fingers processes a received multipath signal in accordance with at least a portion of the stored scrambling code value for providing symbols associated with a path of the received multipath signal.

### BACKGROUND OF THE INVENTION

The present invention generally relates to a receiver architecture for use with Code Division Multiple Access (CDMA) and spread spectrum wireless networks.

CDMA refers to any of several protocols used in so-called second-generation (2G) and third-generation (3G) wireless communications. CDMA is a form of multiplexing that allows numerous signals (channels) to occupy a single physical transmission channel, thereby optimizing bandwidth. These signals are transmitted using the same frequency band and are differentiated by transmitting each signal using a different spreading code.

Spreading codes are used to separate individual signals transmitted from a given base station. Because spreading codes are orthogonal to one another, separate signals can be simultaneously transmitted and separately processed at a receiver. The signals are processed by correlating the received signal against a given spreading code. In contrast, scrambling codes allow signals from different base stations to be differentiated from one another. A scrambling code is used to scramble all of the transmitted signals from a given base station. Accordingly, all signals transmitted from a particular base station are scrambled using the same scrambling code. For example, in the Universal Mobile Telecommunications System (UMTS), a scrambling code covers a UMTS frame (38,400 chips) and comprises 38,400 chip values.

In practice, multiple delayed versions of the transmitted signal arrive at a CDMA receiver. For example, one version of the signal may arrive by traveling a direct path from a base station to the CDMA receiver, while another version may arrive later because the signal reflected off of a building before its arrival. As such, the received signal is also known as a multipath signal and contains multiple delayed versions of the transmitted signal. Each version of the transmitted signal is known as a path.

FIG. 1 is a schematic diagram illustrating a conventional CDMA receiver 100. At a functional level, the CDMA receiver correlates the received samples (101) against different delayed versions of the scrambling code and time-synchronize the outputs of the correlations. As shown, the CDMA receiver includes fingers 105 and 125, scrambling code generators 110 and 130, numerically controlled oscillators (NCOs) 115 and 135, as well as residual generators 120 and 140. The CDMA receiver further includes multiple delays 145 and 150, a maximal ratio combiner (MRC) 155, and a searcher 160.

During decoding, the CDMA receiver processes a received multipath signal (101) to identify the various paths contained therein. This function is performed by the searcher 160. The searcher 160 identifies individual paths of the multipath signal by correlating received samples against different offsets of a scrambling code. Notably, the scrambling code is previously identified by the CDMA receiver from the received multipath signal (e.g., during the known cell search operation). A correlator, or a processor that performs correlations, can demodulate a spread spectrum signal and/or measure the similarity of an incoming signal against a reference.

By adjusting the offset of the scrambling code used for correlation, the searcher 160 performs correlations at different time delays to determine the particular delays at which valid paths exist. The searcher 160 generates a profile, which is a vector of the correlation output at different time delays. This profile is examined to determine the delays of the multipath signal at which various paths are located.

The fingers 105 and 125 can be implemented as baseband correlators. Each finger 105 and 125 processes data from a different time delayed multipath signal. That is, each of the fingers 105 and 125 processes a path of a multipath signal that is located at a particular delay, as determined by the searcher 160. For purposes of illustration, only two fingers have been depicted in FIG. 1. It should be appreciated, however, that CDMA receivers often include more than two fingers, e.g., six.

Each finger traditionally receives the relevant portion of the scrambling code from its own scrambling code generator, which dynamically generates the relevant portion of the scrambling code. As such, fingers 105 and 125 are associated with scrambling code generators 110 and 130 respectively. Often, each scrambling code generator is implemented using a linear feedback shift register (LFSR) architecture. Accordingly, scrambling code generators 110 and 130 require residual generators 120 and 140 respectively for computing initial conditions for each LFSR. Each scrambling code generator also must be linked with a NCO to handle advancing/retarding clock cycles to achieve sub-chip resolution with the scrambling code. Thus, scrambling code generators 110 and 130 are linked with NCOs 115 and 135 respectively.

Each finger 105 and 125 provides symbol output which must be time, or phase, aligned prior to being combined in the MRC 155. As used herein, a symbol refers to a value that typically includes both real and imaginary components. A symbol is generated as the output from correlating the received signal against the spreading code. To time align the symbols, the outputs from fingers 105 and 125 are connected to delays 145 and 150 respectively. The time aligned outputs from delays 145 and 150 are provided to the MRC 155. The MRC 155 uses the pilot corresponding to each symbol to phase align the symbol. The MRC 155 then combines the phase-aligned symbols to provide output signal 156 for subsequent processing.

As is apparent from the above discussion, a significant amount of hardware is required to implement the fingers of the CDMA receiver. In particular, each finger requires a scrambling code generator, a residual generator, and an NCO. As more fingers are used, the amount of required hardware increases significantly. Further, because the output from each finger is not time aligned with other finger outputs, each finger must have a corresponding delay block.

It would be advantageous to provide a hardware-efficient design for a CDMA receiver that overcomes the deficiencies described above.

### SUMMARY OF THE INVENTION

In accordance with the principles of the invention, a receiver comprises a memory for storing a scrambling code value; and a plurality of fingers, wherein each of the fingers processes a received multipath signal in accordance with at least a portion of the stored scrambling code value for providing symbols associated with a path of the received multipath signal.

In an illustrative embodiment, a receiver comprises a sub-chip spaced delay line, a plurality of fingers, a memory and a maximal ratio combiner. The sub-chip spaced delay line provides different delayed versions of samples of a received multipath signal. The sub-chip spaced delay line comprises at least two taps. Individual ones of the different delayed versions of the samples are provided through each of the taps to one of the plurality of fingers. Notably, the different delayed versions of the samples are time aligned when provided from the taps of the sub-chip spaced delay line. Each finger processes the delayed version of the samples using a scrambling code value having a same offset for a given chip, wherein the scrambling code value is provided by the memory. Illustratively, the memory stores a full period of the scrambling code value. The maximal ratio combiner combines those symbols output from the plurality of fingers that are associated with a particular channel.

Another aspect of the present invention includes a method for processing paths of a received multipath signal within a receiver. The method includes storing a scrambling code value in a memory for use in processing a received multi-path signal; and providing at least a portion of the stored scrambling code value to a plurality of fingers for use in providing symbols associated with different paths of the received multipath signal.

### BRIEF DESCRIPTION OF THE DRAWINGS

Preferred embodiments of the present invention will be described below in more detail, with reference to the accompanying drawings, in which:

FIG. 1 is a schematic diagram illustrating aspects of a prior art receiver architecture;

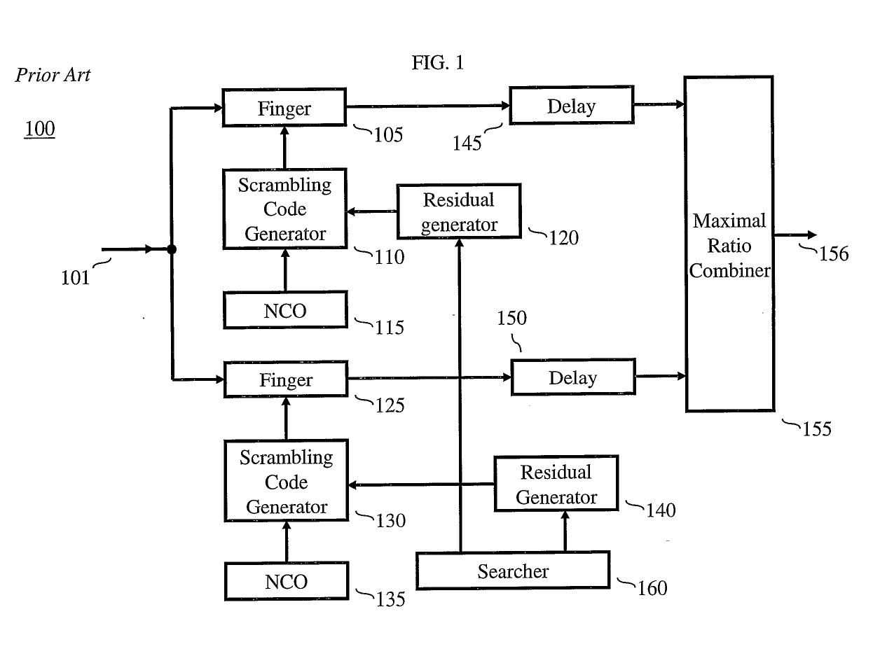

FIG. 2 is a schematic diagram illustrating one embodiment of a receiver in accordance with the inventive arrangements disclosed herein;

FIG. 3 further illustrates scrambling code memory 230 of FIG. 2 in accordance with the principles of the invention; and

FIG. 4 is a flow chart illustrating a method of processing paths of a multipath signal within a receiver in accordance with another embodiment of the present invention,

### DETAILED DESCRIPTION

Other than the inventive concept, the elements shown in the figures are well known and will not be described in detail. Also, familiarity with UMTS-based wireless communications systems is assumed and is not described in detail herein. For example, other than the inventive concept, spread spectrum transmission and reception, cells (base stations), user equipment (UE), downlink channels, uplink channels, the searcher, combiner and RAKE receivers are well known and not described herein. In addition, the inventive concept may be implemented using conventional programming techniques, which, as such, will not be described herein. Finally, like-numbers on the figures represent similar elements.

In accordance with the inventive arrangements disclosed herein, a receiver architecture is provided which utilizes a memory to store a scrambling code for use, e.g., in a CDMA system such as the above-mentioned UMTS. Storing a scrambling code in memory reduces the amount of hardware required to implement the receiver, thereby reducing its complexity and cost.

A sub-chip spaced delay line that buffers received samples of a received multipath signal can also be included in the receiver. This further reduces complexity and cost but is not required for practicing the invention. Appreciably, the use of a sub-chip spaced delay line (also referred to herein as a fractional delay line) obviates the need to perform time alignment as was needed in conventional receiver designs. In conventional designs, the same received sample is correlated against different delayed versions of the scrambling code in each of the fingers. Since the fingers receive the same sample at the same time, the outputs of the various fingers must be delayed appropriately so that the outputs of all fingers can be time-aligned.

In accordance with the inventive arrangements disclosed herein, each finger receives different samples taken from a fractional delay line. Because each finger receives a different sample, the outputs of the fingers are already time-aligned and no further delay oriented processing is needed. The sub-chip spaced delay line can include two or more taps through which individual ones of the different delayed versions of samples can be provided, such that each tap provides samples to one of the plurality of fingers.

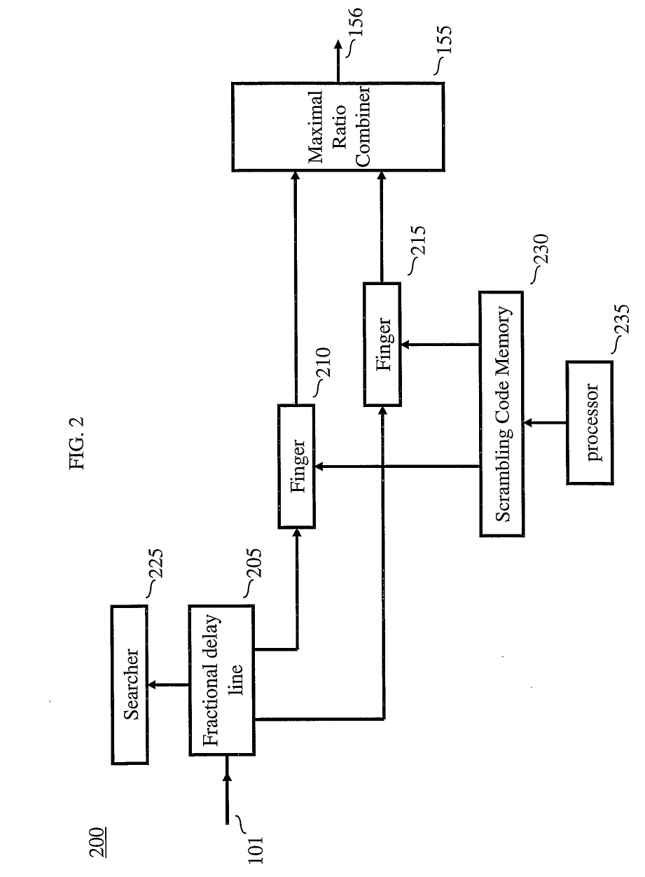

FIG. 2 is a schematic diagram illustrating one embodiment of a receiver in accordance with the inventive arrangements disclosed herein. As shown in FIG. 2, the receiver comprises a fractional delay line 205, two or more fingers as represented by fingers 210 and 215, a maximal ratio combiner (MRC) 155, a searcher 225, a scrambling code memory 230 and a processor 235.

The fractional delay line 205 is a sub-chip spaced delay line. The fractional delay line 205 includes registers that are spaced at delays, or times, of less than a chip, and thus, is said to be sub-chip spaced. As such, the fractional delay line 205 is capable of providing multiple samples as output for a single chip. Because the various outputs provided by the fractional delay line 205 are spaced at intervals of less than a chip, sub-chip resolution can be achieved by the receiver.

The fractional delay line 205 receives samples of a multipath signal (101) and provides different delayed versions thereof. Outputs of the fractional delay line 205, called taps, feed samples to the searcher 225 and each of the fingers 210 and 215. Each tap provides samples as output for a particular one of the different delayed versions of the multipath signal. As a result of the use of the fractional delay line 205, the outputs of the fingers 210 and 215 will be time-aligned.

As known in the art, the searcher 225 performs correlation operations on the multipath signal to determine the particular delays at which valid paths exist. The searcher 225 generates a profile of the multipath signal. The profile is provided to the processor 235. The processor 235 can be any of a variety of microprocessors, controllers, or other embedded and/or programmable processors. Accordingly, the processor 235 can be programmed to analyze the profile of the multipath signal to determine the particular scrambling code value and offset to be used in demodulating the various paths. As known in the art, the scrambling code value is determined during the cell search operation. The processor 235, having identified the scrambling code value and offset, provides this information to the fingers 210 and 215.

However, instead of using LFRs to generate relevant portions of the scrambling code value, the scrambling code value is, in accordance with the principles of the invention, stored in the scrambling code memory 230. The scrambling code memory 230 is illustratively a single memory structure such as a random access memory (RAM) or the like. In one embodiment, the scrambling code memory 230 can be distinct from other components of the receiver. In another embodiment, the scrambling code memory can be included, or embedded, within a processor, such as processor 235. Illustratively, the scrambling code memory of FIG. 2 is chip based and stores a complete period of a scrambling code (e.g., a UMTS frame spans 38,400 chips). It should be noted that each scrambling code value may further comprise in-phase (I) and quadrature (Q) components. Thus, in this example the amount of memory required to store the scrambling code value is equal to: (38400×2) bits.

In any case, in accordance with the principles of the invention, the scrambling code memory 230 stores a substantial portion of the scrambling code value such that particular values thereof are always available for use by the fingers of the receiver. In other words, portions of the scrambling code value are not generated dynamically and, as such, LFSRs do not have to be used. By implementing the scrambling code memory 230 as chip spaced, i.e., storing a single period of the scrambling code, the size can remain relatively small. Notwithstanding the chip spaced memory, sub-chip resolution within the receiver can be achieved due to the inclusion of the fractional delay line 205. In any case, the scrambling code memory 230 can be implemented in any of a variety of different sizes. As such, the present invention is not intended to be limited by the particular size of the scrambling code memory 230.

The fingers 210 and 215 of the receiver can be implemented as baseband correlators. A correlator, or a processor that performs correlations, can demodulate a spread spectrum signal and/or measure the similarity of an incoming signal against a reference. While only 2 fingers are shown in FIG. 2, it should be appreciated that additional fingers can be included depending upon the particular design of the receiver. As such, the present invention is not limited to having or using a particular number of fingers.

The fingers 210 and 215 access the scrambling code memory 230 to obtain the value of the scrambling code at a given offset to be used in processing the multipath signal. With this information, each finger 210 and 215 can be dropped on, or assigned to, a particular valid path of the multipath signal. As each finger 210 and 215 receives samples from a different tap of the fractional delay line 205, each finger 210 and 215 correlates against a different delayed version of the received samples. As noted, each finger 210 and 215 further accesses the scrambling code memory 230 to obtain the value of the scrambling code at an offset that corresponds to the location of the path that the particular finger is assigned. The scrambling code value remains constant for the duration of a chip, but can be updated for subsequent chips.

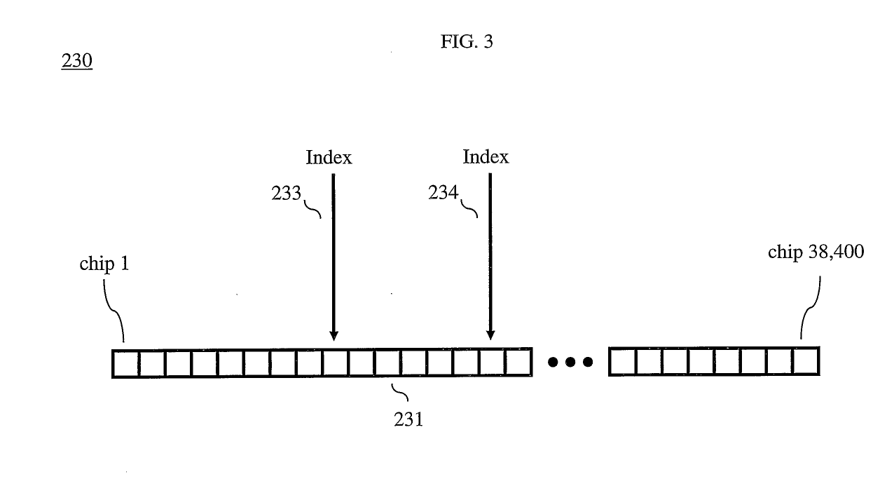

Since the scrambling codes used by each finger 210 and 215 are stored in the scrambling code memory 230, the scrambling codes are generated once and stored, for example by the processor 235. Accordingly, the need for separate scrambling code generators, residual generators, and numerically controlled oscillator hardware for each finger is eliminated, thereby reducing gate count and power consumption. This is further illustrated in FIG. 3, which shows an illustrative chip-based scrambling code memory 230. The latter comprises 38,400 memory locations 231, each memory location storing I and Q values of the scrambling code value. A simple index, or pointer, provides the required offset into the scrambling code value to provide that portion of the scrambling code needed by a respective finger. For example, index 233 points to the scrambling code chip value for use by finger 210; while index 234 points to the scrambling code chip value for use by finger 215. As such, when a finger requires a different scrambling code chip value, the index value for that finger is simply changed—thus pointing to a different scrambling code chip value.

Because the fingers 210 and 215 receive their respective samples from different taps of the fractional delay line 205, the symbols that are output from each finger 210 and 215 are time aligned. As such, the symbols output from each finger 210 and 215 can be provided directly to the MRC 155. Thus, the need for including costly delay hardware at the output of each finger 210 and 215 for time aligning the symbols from fingers 210 and 215 with one another is eliminated.

The symbol output from each finger 210 and 215 is provided directly to the MRC 155. The MRC 155 then constructively combines the symbol output from each of the fingers 210 and 215 for the various channels. More particularly, the symbols from each finger 210 and 215 are added together for a particular channel. The MRC 155 passes the result along to one or more other components and/or systems within the receiver via signal 156.

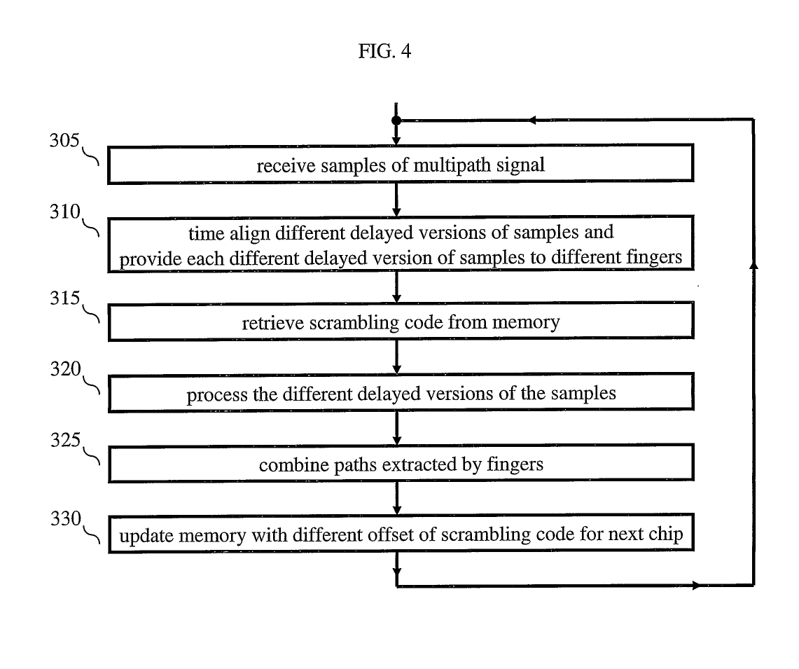

FIG. 4 is a flow chart illustrating a method of processing paths of a multipath signal within a receiver in accordance with another embodiment of the present invention. The method illustratively begins in step 305, where samples of a multipath signal are received, for example by a fractional delay line (e.g., element 205 of FIG. 2). In step 310, each different delayed version of the samples of the multipath signal are provided by a particular output, or tap, of the fractional delay line. Notably, the different delayed versions of samples of the multipath signal, as provided by the various taps, are time aligned with one another and provided to a different finger for processing. That is, each finger can be communicatively linked to its own tap of the fractional delay line.

In step 315, a scrambling code value is retrieved from a location in memory. That is, each of the fingers in the receiver obtains the scrambling code value for an appropriate offset from a single and same memory. Notably, a full, or approximately full, period of the scrambling code can be stored in the memory. In step 320, the different delayed versions of the samples are processed. Specifically, each finger processes a particular delayed version of the samples of the multipath signal to extract a valid path.

In step 325, the paths extracted by the various fingers of the receiver are combined (e.g., by element 155 of FIG. 2). As noted, because the various delayed versions of the multipath signal have been time aligned with one another, no delay processing is required after operation of the fingers. Thus, determined symbols can be provided from each finger directly to the MRC. In step 330, the scrambling code memory, or memory block having suitable logic disposed therein, is updated to provide a different offset of the scrambling code to each of the fingers, e.g., one, or more, of the above-mentioned index values illustrated in FIG. 3 are changed. The update can be performed on a per chip basis, such that for each subsequent chip, a different offset of the scrambling code is used. For example, the offset can be adjusted by a particular and predetermined amount. Thus, each finger receives a different scrambling code on a per chip basis, although the scrambling code used by each finger for any given chip is the same.

The foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs) and/or in one or more stored program-controlled processors (e.g., a microprocessor or digital signal processor (DSP)). Similarly, although illustrated in the context of a UMTS-based system, the inventive concept is applicable to other communications system. It is therefore to be understood that numerous modifications may be made to the illustrative embodiments and that other arrangements may be devised without departing from the spirit and scope of the present invention as defined by the appended claims.

1. A receiver comprising:
a memory for storing a scrambling code value; and a plurality of fingers, wherein each of the fingers processes a received multipath signal in accordance with at least a portion of the stored scrambling code value for providing symbols associated with a path of the received multipath signal.

2. The receiver of claim 1, further comprising a maximal ratio combiner for combining those symbols from the plurality of fingers associated with a particular channel.

3. The receiver of claim 1, further comprising a sub-chip spaced delay line for providing different delayed versions of the received multipath signal to each of the plurality of fingers.

4. The receiver of claim 3, wherein the sub-chip spaced delay line has at least two taps, and wherein individual ones of the different delayed versions of the received multipath signal are provided through each of the taps.

5. The receiver of claim 4, wherein the different delayed versions of the received multipath signal are time aligned when provided from said taps of the sub-chip spaced delay line.

6. The receiver of claim 1, wherein the memory includes a full period of the scrambling code value.

7. The receiver of claim 1, wherein the memory stores chip based values of the scrambling code.

8. The receiver of claim 1, wherein the at least a portion of the stored scrambling code value is updated on a per chip basis.

9. The receiver of claim 1, further comprising a searcher for identifying valid paths within the received multipath signal and for assigning each of the plurality of fingers thereto.

10. A method for use in a receiver, the method comprising:
storing a scrambling code value in a memory for use in processing a received multipath signal; and
providing at least a portion of the stored scrambling code value to a plurality of fingers for use in providing symbols associated with different paths of the received multipath signal.

11. The method of claim 10, further comprising the step of combining those symbols associated with the different paths that are associated with a particular channel.

12. The method of claim 10, wherein the providing step includes the step of using different offsets of the stored scrambling code value to obtain the at least one portion of the stored scrambling code value on a per chip basis, wherein the at least one portion of the stored scrambling code value provided to each finger in a given chip is the same.

13. The method of claim 10, wherein the stored scrambling code value represents a full period of the scrambling code.

14. The method of claim 10, wherein the stored scrambling code value is chip based.

15. A receiver comprising:
a processor for determining a scrambling code value from a received multipath signal; and
a memory for storing the scrambling code value.

16. The receiver of claim 15, further comprising
a plurality of fingers, wherein each of the fingers processes the received multipath signal in accordance with at least a portion of the stored scrambling code value for providing symbols associated with a path of the received multipath signal.

17. The receiver of claim 16, wherein the at least a portion of the stored scrambling code value is updated on a per chip basis.

18. The receiver of claim 16, further comprising a searcher for identifying valid paths within the received multipath signal and for assigning each of the plurality of fingers thereto.

19. The receiver of claim 16, further comprising a maximal ratio combiner for combining those symbols from the plurality of fingers associated with a particular channel.

20. The receiver of claim 16, further comprising a sub-chip spaced delay line for providing different delayed versions of the received multipath signal to each of the plurality of fingers.

21. The receiver of claim 20, wherein the sub-chip spaced delay line has at least two taps, and wherein individual ones of the different delayed versions of the received multipath signal are provided through each of the taps.

22. The receiver of claim 21, wherein the different delayed versions of the received multipath signal are time aligned when provided from said taps of the sub-chip spaced delay line.

23. The receiver of claim 15, wherein the memory includes a full period of the scrambling code value.

24. The receiver of claim 15, wherein the memory stores chip based values of the scrambling code.

25. A method for use in a receiver, the method comprising:
processing a received multipath signal to determine therefrom a scrambling code value; and
storing the scrambling code value in a memory for use in subsequent processing of the received multi-path signal.

26. The method of claim 25, further comprising the step of
providing at least a portion of the stored scrambling code value to a plurality of fingers for use in providing symbols associated with different paths of the received multipath signal.

27. The method of claim 26, further comprising the step of combining those symbols associated with the different paths that are associated with a particular channel.

28. The method of claim 26, wherein the providing step includes the step of using different offsets of the stored scrambling code value to obtain the at least one portion of the stored scrambling code value on a per chip basis, wherein the at least one portion of the stored scrambling code value provided to each finger in a given chip is the same.

29. The method of claim 25, wherein the stored scrambling code values represents a full period of the scrambling code.

30. The method of claim 25, wherein the stored scrambling code value is chip based.
